(19) United States
(12) Patent Application Publication
(10) Pub. No.: US 2026/0298888 A1
(43) Pub. Date: Oct. 1, 2026

(54) METHOD FOR MEASURING CHLORINATED PARAFFIN

(71) Applicant: SHIMADZU CORPORATION, Kyoto-shi (JP)

(72) Inventors: Kenichi OBAYASHI, Kyoto-shi (JP); Xue CHU, Kyoto-shi (JP); Shota HATA, Kyoto-shi (JP)

(21) Appl. No.: 19/480,687

(22) PCT Filed: Jan. 23, 2024
(86) PCT No.: PCT/JP2024/001827

§ 371 Date: Oct. 31, 2025

(30) Foreign Application Priority Data
May 2, 2023 (JP) 2023-076228

(51) Int. Cl. G01N 30/72; G01N 30/02

(52) U.S. Cl. CPC G01N 30/7206; G01N 2030/025

(57) ABSTRACT

A method for measuring a chlorinated paraffin is a method for measuring a sample containing at least one chlorinated paraffin selected from short-chain chlorinated paraffins and medium-chain chlorinated paraffins by gas chromatography-mass spectrometry, the method comprising: ionizing the chlorinated paraffin in an atmosphere containing a vaporized organic solvent in an ion source of a mass spectrometry section.

### TECHNICAL FIELD

The present invention relates to a method for measuring a chlorinated paraffin.

### BACKGROUND ART

Chlorinated paraffins are used in various applications such as flame retardants and lubricating oil additives. Among these, short-chain chlorinated paraffins (SCCPs) are banned from production, import, and export under the POPs Convention, and medium-chain chlorinated paraffins (MCCPs) were also recently registered as candidate substances for the 25th SVHC (Substances of Very High Concern), so they may become subject to regulation in the future.

As a method for detecting such short-chain chlorinated paraffins and medium-chain chlorinated paraffins, gas chromatography-mass spectrometry (GC/MS method) can be mentioned. In the gas chromatography-mass spectrometry method, a measurement sample is separated into various components by gas chromatography, and then the various components are qualitatively and quantitatively analyzed by mass spectrometry. In this mass spectrometry, an electron ionization method, in which a measurement sample is directly irradiated with electrons to be ionized, is generally used in the ion source that ionizes the various components.

However, when the electron ionization method is used for chlorinated paraffins, which have many homologues and isomers, fragmentation occurs in which the chlorinated paraffins are finely fragmented, making it difficult to identify which chlorinated paraffin the resulting ions originate from. A gas chromatography-mass spectrometry method for suppressing such fragmentation is stipulated in ISO 2281:2021 (Non-Patent Literature 1).

In the method of Non-Patent Literature 1, a negative chemical ionization method, which is a soft ionization method, is employed in the mass spectrometry section. Specifically, a reagent gas is filled in an ion source together with the chlorinated paraffin and irradiated with electrons to generate reagent ions from the reagent gas, and the chlorinated paraffin is indirectly ionized by the collision between the reagent ions and the chlorinated paraffin.

### PRIOR ART DOCUMENTS

### Non-Patent Literature

Non-Patent Literature 1: “ISO 2281:2021”, https://www.iso.org/standard/73989.html, [searched on Apr. 24, 2023], Internet

### SUMMARY OF THE INVENTION

### Problem to be Solved by the Invention

However, the negative chemical ionization method uses methane, isobutane, ammonia, or the like as a reagent gas. Since these are flammable gases, they are difficult to handle, and facilities that can introduce this method are limited from the viewpoint of ensuring safety.

An object of the present invention is to provide a method for measuring a chlorinated paraffin in a safer manner.

### Means for Solving the Problem

A method for measuring a chlorinated paraffin according to a first aspect of the present invention is a method for measuring a sample containing at least one chlorinated paraffin selected from short-chain chlorinated paraffins and medium-chain chlorinated paraffins by gas chromatography-mass spectrometry, wherein the chlorinated paraffin is ionized in an atmosphere containing a vaporized organic solvent in an ion source of a mass spectrometry section.

### Effects of the Invention

According to the method for analyzing a chlorinated paraffin of the first aspect, safety is excellent because it is not necessary to use a flammable gas.

### BRIEF DESCRIPTION OF THE DRAWINGS

FIG. 1 is a schematic view showing a GC-MS apparatus used in the measurement method of the first embodiment.

FIG. 2 is a schematic view of an ion source in FIG. 1.

FIG. 3 is a schematic view of a solvent introduction part in FIG. 1.

FIG. 4 is a mass chromatogram of a short-chain chlorinated paraffin measured in Example 1, where the vertical axis represents intensity and the horizontal axis represents retention time.

FIG. 5 is a mass chromatogram of the short-chain chlorinated paraffin measured in Example 1.

FIG. 6 is a mass chromatogram of a short-chain chlorinated paraffin measured in Comparative Example 1.

FIG. 7 is a mass chromatogram of the short-chain chlorinated paraffin measured in Comparative Example 1.

FIG. 8 is a mass chromatogram of a medium-chain chlorinated paraffin measured in Example 2.

FIG. 9 is a mass chromatogram of the medium-chain chlorinated paraffin measured in Example 2.

FIG. 10 is a mass chromatogram of a medium-chain chlorinated paraffin measured in Comparative Example 2.

FIG. 11 is a mass chromatogram of the medium-chain chlorinated paraffin measured in Comparative Example 2.

### DESCRIPTION OF EMBODIMENTS

### 1. First Embodiment

The analysis method of the first embodiment of the present invention is a method for measuring a chlorinated paraffin contained in a measurement sample by gas chromatography-mass spectrometry. That is, the measurement sample is separated by gas chromatography, and subsequently, the separated measurement sample is detected by mass spectrometry.

The chlorinated paraffin contained in the measurement sample and to be analyzed is a short-chain chlorinated paraffin and/or a medium-chain chlorinated paraffin. Short-chain chlorinated paraffins (SCCPs) are chlorinated paraffins having 10 to 13 carbon atoms, represented by C_{10+n′}H_{22+2n′-k}Clₖ (where n′ is an integer of 0 to 3, and k is an integer of 1 to [22+2n′]). Medium-chain chlorinated paraffins (MCCPs) are chlorinated paraffins having 14 to 17 carbon atoms, represented by C_{10+n″}H_{22+2n″-m}Clₘ (where n″ is an integer of 4 to 7, and m is an integer of 1 to [22+2n″]). The chlorinated paraffin may have a linear structure or a branched structure. In the first embodiment, it is preferable to analyze at least one chlorinated paraffin represented by C₁₀₊ₙH₁₅₊₂ₙCl₇ (where n is an integer of 0 to 7), and it is particularly preferable to measure all of the chlorinated paraffins consisting of C₁₀H₁₅C₁₇, C₁₁H₁₇C₁₇, C₁₂H₁₉C₁₇, C₁₃H₂₁C₁₇, C₁₄H₂₃C₁₇, C₁₅H₂₅Cl₇, C₁₆H₂₇Cl₇, and C₁₇H₂₉Cl₇, that is, to analyze them all at once.

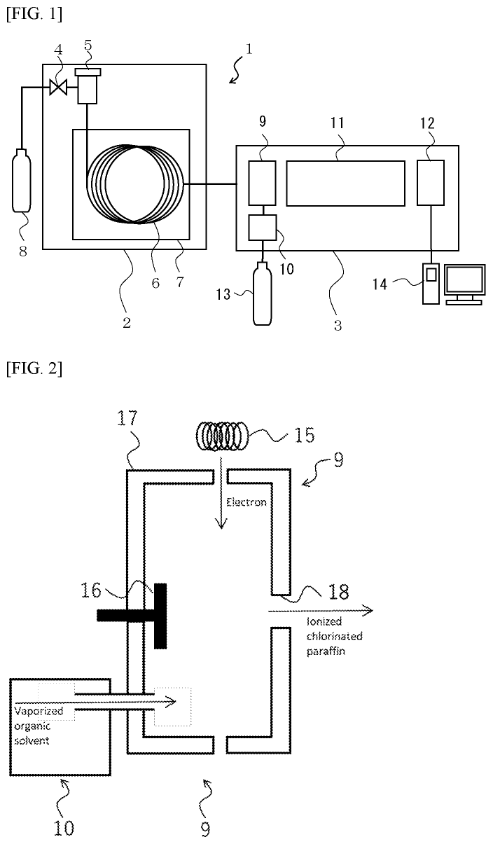

In the first embodiment, a gas chromatograph-mass spectrometer is used. A schematic diagram of a gas chromatograph-mass spectrometer (GC-MS apparatus) 1 is shown in FIGS. 1 to 3. This GC-MS apparatus 1 includes a gas chromatograph section (GC section) 2 and a mass spectrometry section (MS section) 3.

The GC section 2 includes a carrier gas flow control part 4, a sample vaporization chamber 5, a column 6, and a column oven 7. A GC carrier gas cylinder 8 is connected to the upstream side of the carrier gas flow control part 4.

A sample injection port for injecting a sample is formed at the end of the sample vaporization chamber 5, and the sample is introduced into the sample vaporization chamber 5 from the sample injection port. The sample vaporization chamber 5 is equipped with a heating device (for example, a heater; not shown) for vaporizing the sample.

The stationary phase in the column 6 may be any that can retain chlorinated paraffins, and examples include methyl silicone-based, phenylmethyl-based, cyanopropylphenyl-based, trifluoropropyl-based, and polyethylene glycol-based, with methyl silicone-based being preferable. As for the polarity of the stationary phase, a suitable one can be selected from nonpolar, low-polar, medium-polar, and high-polar. It may be either a capillary column or a packed column. Specific examples of such columns include the SH-1 series and SH-5 series manufactured by Shimadzu Corporation.

The MS section 3 includes an ion source 9, a solvent introduction part 10, a mass separator 11, and a detector 12. A solvent introduction gas cylinder 13 is connected to the sample introduction part 10. A data processing device 14 is electrically connected to the detector 12.

The ion source 9 is a device (ionization part) that ionizes the sample. The ion source 9 includes a filament 15 that generates electrons, a repeller electrode 16 that guides the ionized sample to the mass separator 11, and a chamber 17. The repeller electrode 16 is negatively charged, and an opening 18 leading to the mass separator 11 is formed on the side wall of the chamber 17 opposite the repeller electrode 16. Further, as shown in FIG. 1, a solvent introduction part 10 for introducing a vaporized organic solvent into the ion source 9 is connected to the ion source 9.

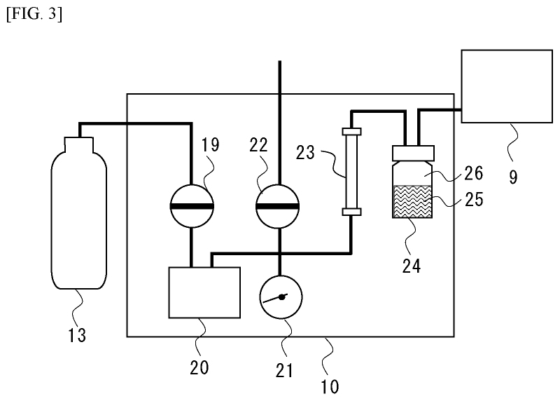

As shown in FIG. 3, the solvent introduction part 10 includes a pressure valve 19, a pressure regulator 20, a pressure gauge 21, a vent valve 22, a filter 23, and a reagent container 24. An organic solvent 25 is injected into the reagent container 24, and a headspace (gas phase portion) 26 for the organic solvent 25 to vaporize (particularly, volatilize) is provided in the upper part inside the reagent container 24. That is, the lower part of the reagent container 24 is filled with the organic solvent, and the headspace 26 is filled with the volatilized organic solvent. The pressure in the headspace 26 is atmospheric pressure at the start of measurement. By opening or closing the pressure valve 19 and the vent valve 22 and setting the pressure regulator 20, an inert gas flows in from the solvent introduction gas cylinder 23, and a predetermined pressure is applied within the reagent container 24. The filter 23 is packed with molecular sieves, which adsorb impurity gases (e.g., oxygen) contained in the inert gas to suppress contamination of the ion source 9.

Examples of the separation format of the mass separator 11 include quadrupole type, magnetic sector type, time-of-flight type, ion trap type, and ion cyclotron resonance type. The mass separator 11 may also be a tandem mass spectrometry type composed of multiple units. That is, in the first embodiment, a gas chromatography-tandem mass spectrometry method may be adopted. Examples of the tandem mass spectrometry type include triple quadrupole type (Q-Q), tandem time-of-flight type (TOF-TOF), quadrupole-time-of-flight type (Q-TOF), quadrupole-ion trap type (Q-IT), quadrupole-ion cyclotron resonance type (Q-ICR), and ion trap-time-of-flight type (IT-TOF).

Specific examples of such a GC-MS apparatus 1 include the GCMS-QP series and GCMS-TQ series manufactured by Shimadzu Corporation.

In the first embodiment, the chlorinated paraffin is separated by gas chromatography (GC step), and then the separated chlorinated paraffin is measured by a mass spectrometer (MS step). Hereinafter, each step will be described.

In the GC step, the chlorinated paraffin, which is the measurement sample, is vaporized in the sample vaporization chamber 5. The vaporized chlorinated paraffin passes through the column 6 together with the carrier gas flowing from the GC carrier gas cylinder 8, is separated according to retention time, and is then guided to the MS section 3.

The temperature of the sample vaporization chamber 5 may be set to be equal to or higher than the boiling point of the chlorinated paraffin to be measured, for example, 250° C. or higher, preferably 300° C. or higher. The temperature condition may be either a temperature-programmed method or an isothermal method. For example, in the temperature-programmed method, the temperature may be raised from an initial temperature of 100° C. or lower to the boiling point of the measurement sample or higher (for example, 250° C. or higher) at a constant rate of temperature increase.

Examples of the carrier gas introduced into the column 6 include helium, nitrogen, hydrogen, argon, and the like, with helium being preferable. These may be used alone or in combination of two or more. The flow rate of the carrier gas may be set according to conventional methods.

In the MS step, the chlorinated paraffin is ionized in the ion source 9, the ionized chlorinated paraffin is separated or selected according to m/z (mass-to-charge ratio) in the mass separator 11, and the ionized paraffin is detected in the detector 12.

First, in the ion source 9, the chlorinated paraffin introduced from the GC section 2 is ionized. At this time, in addition to the chlorinated paraffin, a vaporized organic solvent is introduced into the chamber 17. Specifically, by adjusting the pressure valve 19, the vent valve 22, and the pressure regulator 20, the inert gas in the sample introduction gas cylinder 13 is introduced into the reagent container 24, thereby applying a predetermined pressure to the organic solvent 25 in the reagent container 24.

Examples of the organic solvent injected into the reagent container 24 include volatile organic solvents such as methanol, acetonitrile, acetone, hexane, isopropanol, cyclohexane, and toluene. These may be used alone or in combination of two or more. Among these, methanol, acetone, hexane, or isopropanol is preferable for efficient ionization, and methanol is more preferable because it has a relatively high vapor pressure and particularly low proton affinity.

Examples of the inert gas in the sample introduction gas cylinder 13 include argon, helium, nitrogen, and the like. These may be used alone or in combination of two or more.

The pressure applied to the organic solvent 25 in the reagent container 24, that is, the pressure indicated by the pressure gauge 21, is, for example, 10 kPa or more, preferably 30 kPa or more, and, for example, 100 kPa or less, preferably 80 kPa or less. By setting it to 10 kPa or more, the organic solvent can be introduced into the ion source 9, and fragmentation of the chlorinated paraffin can be suppressed. Further, by setting it to 30 kPa or more, a sufficient amount of organic solvent can be introduced into the ion source 9, and fragmentation of the chlorinated paraffin can be more reliably suppressed, so that the S/N ratio, and thus the measurement accuracy, can be improved.

The flow rate of the inert gas into the reagent container 24, and thus the flow rate into the ion source 9, is, for example, 0.10 mL/min or more, preferably 0.40 mL/min or more, and, for example, 1.00 mL/min or less, preferably 0.70 mL/min or less.

As a result, thermal electrons generated from the filament 15 and passing through the chamber 17 lose energy due to collision or ionization reaction with the vaporized organic solvent before colliding with the chlorinated paraffin, and are then captured by the chlorinated paraffin (electron capture reaction). Therefore, the chlorinated paraffin is ionized in a state where fragmentation is suppressed.

The chlorinated paraffin ionized in the ion source 9 is a negative ion such as [M-Cl]⁻, [M-2Cl]⁻, [M-HCl]⁻, and preferably [M-Cl]⁻. M represents each chlorinated paraffin.

Thereafter, the ionized chlorinated paraffin is separated or selected for each m/z in the mass separator 11 and detected in the detector 12.

As an example of the m/z to be monitored (monitoring m/z) according to the type of chlorinated paraffin, the numerical values of the quantitation ions described in Table 1 of the Examples can be mentioned. At this time, in addition to the main ion (in Table 1, the quantitation ion), other ions may be confirmed as the ions to be monitored. That is, in addition to the quantitation ion, a confirmation ion is also monitored. This makes it possible to reliably identify the type of chlorinated paraffin. The confirmation ion may be an ion corresponding to a chlorine isotope of the quantitation ion.

As a result, a mass chromatogram for each m/z is obtained, and by observing these mass chromatograms, qualitative and quantitative analysis of various chlorinated paraffins contained in the sample becomes possible.

In the first embodiment, a chlorinated paraffin can be measured. In particular, since the chlorinated paraffin separated in the GC section can be ionized and subjected to mass analysis while suppressing fragmentation without using a flammable gas such as methane gas, the handling of the materials and apparatus used for the measurement is easy, that is, the safety is high. In addition, since the peak height of the obtained mass chromatogram is good, high-sensitivity measurement is possible. Furthermore, since the S/N ratio in the mass chromatogram is good, high-precision measurement is possible. In the measurement method of the first embodiment, the methods described in Japanese Patent No. 7188441, U.S. Pat. No. 11,482,405, European DE 112019001764, etc., can also be referred to.

### 2. Aspects

Those skilled in the art will understand that the exemplary embodiments described above are specific examples of the following aspects.

(First Aspect) A method for measuring a chlorinated paraffin according to one aspect may be a method for measuring a sample containing at least one chlorinated paraffin selected from short-chain chlorinated paraffins and medium-chain chlorinated paraffins by gas chromatography-mass spectrometry, wherein the separated chlorinated paraffin may be ionized in an atmosphere containing a vaporized organic solvent in an ion source of a mass spectrometry section.

(Second Aspect) In the measurement method according to the first aspect, the chlorinated paraffin may be at least one compound represented by C₁₀₊ₙH₁₅₊₂nCl₇ (where n is an integer of 0 to 7).

(Third Aspect) In the measurement method according to the first or second aspect, the organic solvent may be methanol.

(Fourth Aspect) In the measurement method according to any one of the first to third aspects, the organic solvent may be supplied to the ion source by applying a pressure of 10 kPa or more to the organic solvent.

(Fifth Aspect) In the measurement method according to any one of the first to fourth aspects, the organic solvent may be supplied to the ion source by applying a pressure of 30 kPa or more to the organic solvent.

### EXAMPLES

Next, the present invention will be described in detail with reference to Examples and Comparative Examples, but the scope of the present invention is not limited thereto.

### Example 1: Measurement of Short-Chain Chlorinated Paraffins

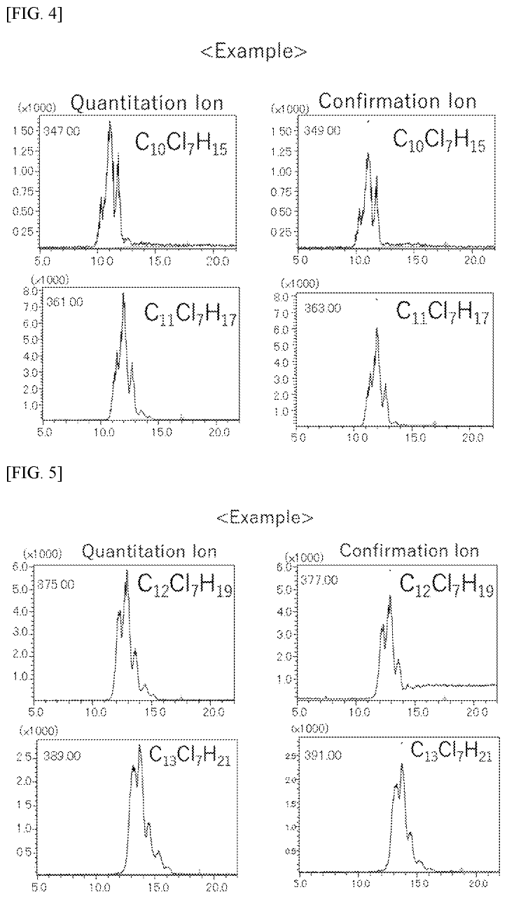

A measurement sample for SCCPs was prepared by mixing 533 μL of an SCCP standard sample (100 μg/mL, Cl 55.5%) and 467 μL of an SCCP standard sample (100 μg/mL, Cl 66%). The measurement sample for SCCPs was measured under the following conditions using a gas chromatograph-mass spectrometer (“GCMS-QP2020NX”, manufactured by Shimadzu Corporation, see FIGS. 1 to 3). Immediately before the start, about half of the reagent container was filled with methanol, and the pressure in the headspace was atmospheric pressure. The mass chromatograms obtained from this measurement result are shown in FIGS. 4-5.

### [Gas Chromatograph Section]

Injection mode: Splitless
Vaporization chamber temperature: 300° C.
Column oven temperature: Heated from 80° C. at 20° C./min, then 320° C. (4 min)
Column: SH-1MS with guard column (nonpolar liquid phase: dimethylpolysiloxane, film thickness 0.1 μm, length 19 m, inner diameter 0.25 mm, guard column 2 m)
Carrier gas: Helium
Carrier gas control mode: Constant linear velocity (52.1 cm/sec)
Purge flow rate: 3.0 mL/min

### [Mass Spectrometry Section]

Organic solvent introduced into ion source: Methanol
Ionization method: Solvent-mediated chemical ionization using methanol
Ion source temperature: 230° C.
Interface temperature: 320° C.
Ionization voltage: 70 eV
Type of gas supplied to reagent container: Argon
Pressure of gas supplied to reagent container: 40 kPa
Flow rate of gas supplied to reagent container: 0.45 mL/min
Mass spectrometer: Single quadrupole type
Measurement mode: Simultaneous Scan/SIM (Selected Ion Monitoring) measurement
Scan event time: 0.15 sec
Scan mass range: m/z 50-1000
SIM event time: 0.30 sec
SIM monitoring m/z: See Table 1 below

TABLE 1

m/z

| | Composition | Quantitation | Confirmation |
|---|---|---|---|
| | Formula | Ion | Ion |
| Short-chain | C₁₀H₁₅Cl₇ | 347 | 349 |
| chlorinated | C₁₁H₁₇Cl₇ | 361 | 363 |
| paraffin | C₁₂H₁₉Cl₇ | 375 | 377 |
| | C₁₃H₂₁Cl₇ | 389 | 391 |
| Medium- | C₁₄H₂₃Cl₇ | 403 | 405 |
| chain | C₁₅H₂₅Cl₇ | 417 | 419 |
| chlorinated | C₁₆H₂₇Cl₇ | 431 | 433 |
| paraffin | C₁₇H₂₉Cl₇ | 445 | 447 |

### Comparative Example 1

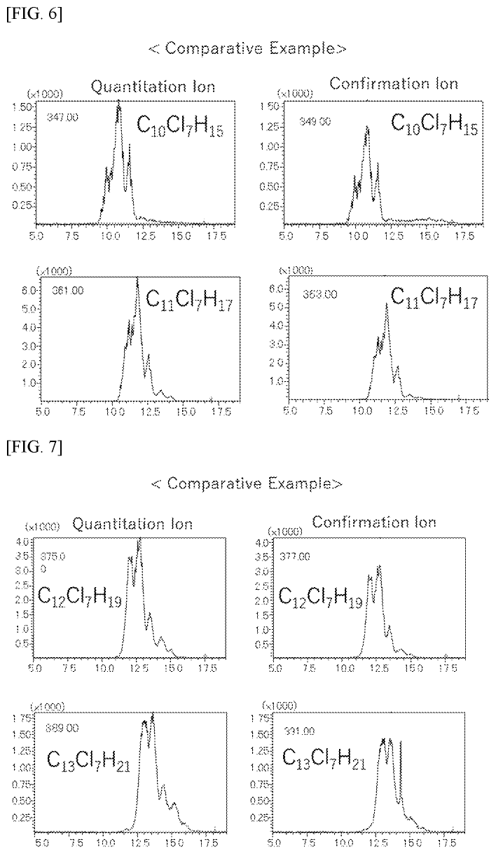

The measurement was carried out in the same manner as in Example 1, except that the SCCP measurement sample was ionized in the ion source by a negative chemical ionization method using methane gas. The results are shown in FIGS. 6-7.

From FIGS. 4-5 and FIGS. 6-7, it can be seen that the mass chromatogram of the measurement method according to Example 1 shows peaks similar to those of the mass chromatogram of the conventional measurement method using methane gas, indicating that the short-chain chlorinated paraffins can be measured by the measurement method of Example 1. In addition, for all short-chain chlorinated paraffins, the peak height of the mass chromatogram of Example 1 is higher than the peak height of the mass chromatogram of Comparative Example 1, indicating that the measurement method of Example 1 has high sensitivity.

### Example 2: Measurement of Medium-Chain Chlorinated Paraffins

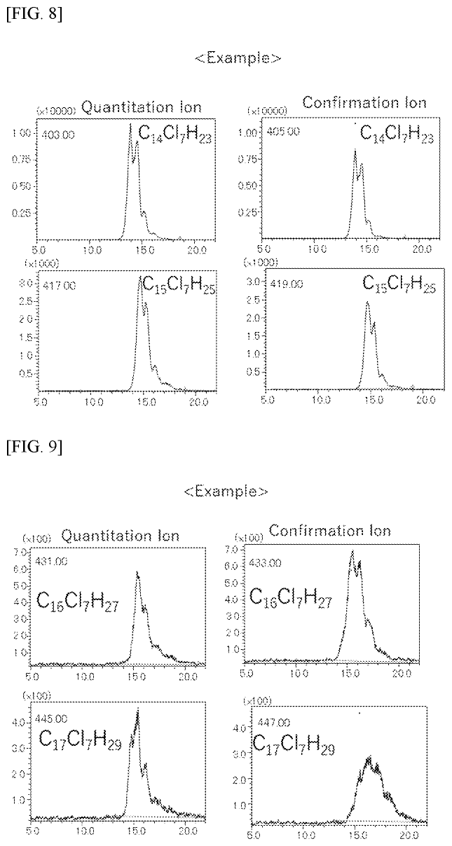

A measurement sample for MCCPs was prepared by mixing 400 μL of an MCCP standard sample (100 μg/mL, Cl 52%) and 600 μL of an MCCP standard sample (100 μg/mL, Cl 57%). The measurement was carried out in the same manner as in Example 1, except that the MCCP measurement sample was used as the measurement target. The results are shown in FIGS. 8-9.

### Comparative Example 2

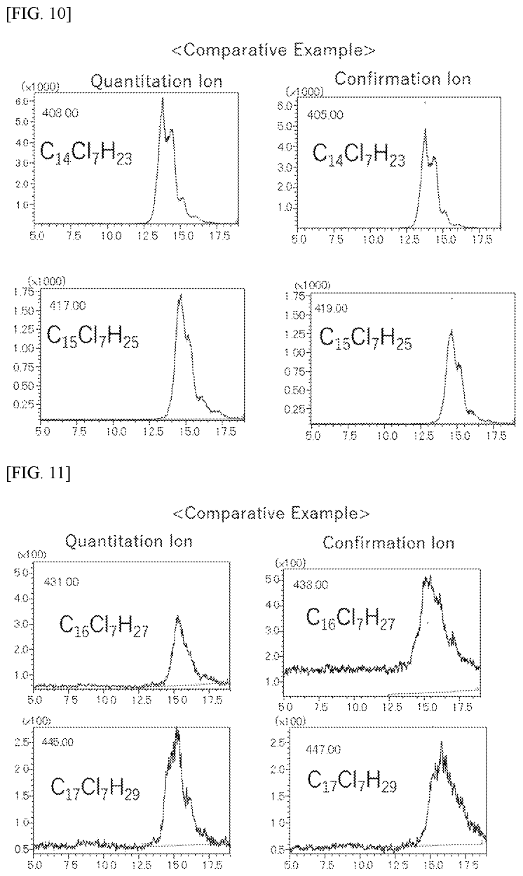

The measurement was carried out in the same manner as in Example 2, except that the sample was ionized in the ion source by a negative chemical ionization method using methane gas. The results are shown in FIGS. 10-11.

From FIGS. 8-9 and FIGS. 10-11, it can be seen that the mass chromatogram of the measurement method according to Example 2 shows peaks similar to those of the mass chromatogram of the conventional measurement method using methane gas, indicating that the medium-chain chlorinated paraffins can be measured by the measurement method of Example 2. In addition, for all medium-chain chlorinated paraffins, the peak height of the mass chromatogram of Example 2 is higher than the peak height of the mass chromatogram of Comparative Example 2, indicating that the measurement method of Example 2 has high sensitivity.

### Example 3

Measurements were carried out in the same manner as in Example 1 (short-chain chlorinated paraffins) and Example 2 (medium-chain chlorinated paraffins), except that the pressure of the gas supplied to the reagent container was changed to 20 kPa and the flow rate of the gas supplied to the reagent container was changed to 0.39 mL/min.

The S/N ratios for Examples 1-2 at this time were calculated in accordance with ASTM regulations. The results are shown in Table 2. From Table 2, it can be seen that the measurement conditions of Examples 1-2 have a higher S/N ratio and thus better accuracy.

TABLE 2

S/N Ratio

| | | Examples 1-2 | Example 3 |
|---|---|---|---|
| | Composition | (Pressurized | (Pressurized |
| | Formula | at 40 kPa) | at 20 kPa) |
| Short-chain | C₁₀H₁₅Cl₇ | 3.4 | 2.6 |
| chlorinated | C₁₁H₁₇Cl₇ | 15.0 | 11.3 |
| paraffin | C₁₂H₁₉Cl₇ | 10.6 | 7.7 |
| | C₁₃H₂₁Cl₇ | 6.8 | 3.7 |
| Medium- | C₁₄H₂₃Cl₇ | 20.4 | 4.4 |
| chain | C₁₅H₂₅Cl₇ | 7.3 | 1.5 |
| chlorinated | C₁₆H₂₇Cl₇ | 1.7 | 0.4 |
| paraffin | C₁₇H₂₉Cl₇ | 2.0 | 0.6 |

### DESCRIPTION OF THE REFERENCE NUMERALS

1 Gas chromatograph-mass spectrometer
2 Gas chromatograph section
3 Mass spectrometry section
4 Carrier gas flow control part
5 Sample vaporization chamber
6 Column
7 Column oven
8 Gas chromatograph carrier gas cylinder
9 Ion source
10 Solvent introduction part
11 Mass separator
12 Detector
13 Solvent introduction gas cylinder
14 Data processing device
15 Filament
16 Repeller electrode
17 Chamber
18 Opening
19 Pressure valve
20 Pressure regulator
21 Pressure gauge
22 Vent valve
23 Filter
24 Reagent container
25 Organic solvent
26 Headspace

1. A method for measuring a chlorinated paraffin, for measuring a sample containing at least one chlorinated paraffin selected from short-chain chlorinated paraffins and medium-chain chlorinated paraffins by gas chromatography-mass spectrometry, the method comprising:
ionizing the chlorinated paraffin in an atmosphere containing a vaporized organic solvent in an ion source of a mass spectrometry section.

2. The method for measuring according to claim 1, wherein the chlorinated paraffin is at least one compound represented by C₁₀₊ₙH₁₅₊₂ₙCl₇ (where n is an integer of 0 to 7).

3. The method for measuring according to claim 1, wherein the organic solvent is methanol.

4. The method for measuring according to claim 1, wherein the organic solvent is supplied to the ion source by applying a pressure of 10 kPa or more to the organic solvent.

5. The method for measuring according to claim 1, wherein the organic solvent is supplied to the ion source by applying a pressure of 30 kPa or more to the organic solvent.
